(19) United States
(12) Patent Application Publication
(10) Pub. No.: US 2009/0174979 A1
(43) Pub. Date: Jul. 9, 2009

(54) Current Limiter Having Overload Indication Function

(76) Inventor: Wen-Ho Yang, Bali (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/970,792

(22) Filed: Jan. 8, 2008

(51) Int. Cl. H02H 3/08; F21V 11/00; F21V 7/00

(52) U.S. Cl. 361/93.9; 361/100; 362/351; 362/341

(57) ABSTRACT

A current limiter includes a circuit device including a power supply transformation circuit to transform a power supply, a detection circuit to detect and transform a load current of a load into an output voltage, a control circuit to interrupt a connection between the power supply and the load according to the output voltage, a reset switch circuit to connect the power supply with the load, and a protection circuit including a warning element. Thus, when the power of the load exceeds a predetermined value, the current limiter will shut the power supply automatically to turn off the load to prevent the load from being worn out due to an excessive load current and to turn on the warning element to inform a user of the overload of the load.

### BACKGROUND OF THE INVENTION

1. Field of the Invention

The present invention relates to an emergency protective circuit device and, more particularly, to a current limiter that limits a load power of a load, such as an illuminating lamp.

2. Description of the Related Art

A current limiter is used to limit a load power (such as 190 W) of a lamp to prevent the lamp from being burnt or worn out due to an excessive load current. The control circuit structure of the conventional current limiter comprises a sampling circuit, a rectification filter circuit, an amplification comparison circuit and an output control circuit. The amplification comparison circuit includes a current transformer, a comparator, a silicon control rectifier (SCR) and a relay. When the load current of the illuminating lamp exceeds a predetermined value, the relay is actuated by the silicon control rectifier to turn off the lamp to prevent the lamp from being burnt or worn out due to an excessive load current. However, the conventional current limiter has a complicated construction, an unstable performance, lower precision and reliability and a higher cost of maintenance.

### BRIEF SUMMARY OF THE INVENTION

In accordance with the present invention, there is provided a current limiter, comprising current limiter, comprising a circuit device. The circuit device comprises a power supply transformation circuit to transform an alternating-current power supply into a direct-current power supply, a detection circuit to sense and detect a load current from a load and to transform the load current of the load into an output voltage with a predetermined ratio, a first relay electrically connected between the load and the detection circuit, a control circuit electrically connected between the detection circuit and the power supply transformation circuit to drive a first silicon control rectifier and a second relay according to the output voltage of the detection circuit to interrupt a connection between the power supply and the load so as to turn off the load, a reset switch circuit electrically connected with the detection circuit and including a second silicon control rectifier, a capacitor electrically connected with the second silicon control rectifier and a reset switch electrically connected with the capacitor to trigger the second silicon control rectifier to connect the power supply with the load so as to turn on the load, and a protection circuit electrically connected with the first relay and including a warning element.

The primary objective of the present invention is to provide a current limiter a current limiter having an overload indication function.

Another objective of the present invention is to provide a current limiter that limits a load current (or power) of a load and indicates an overload of the load.

A further objective of the present invention is to provide a current limiter, wherein when the power of the load exceeds a predetermined value, the current limiter will shut the power supply automatically to turn off the load so as to prevent the load from being worn out due to an excessive load current and to turn on the warning element of the protection circuit so as to inform a user of the abnormal condition due to the overload of the load.

A further objective of the present invention is to provide a current limiter, wherein the power supply transformation circuit has a smaller volume and has a simplified structure, thereby saving the space and the price.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a circuit layout of a circuit device of a current limiter in accordance with the preferred embodiment of the present invention.

FIG. 2 is an exploded perspective view of a lamp device of the current limiter in accordance with the preferred embodiment of the present invention.

FIG. 3 is a front cross-sectional assembly view of the lamp device of the current limiter as shown in FIG. 2.

FIG. 4 is an exploded perspective view of a lamp device of the current limiter in accordance with another preferred embodiment of the present invention.

### DETAILED DESCRIPTION OF THE INVENTION

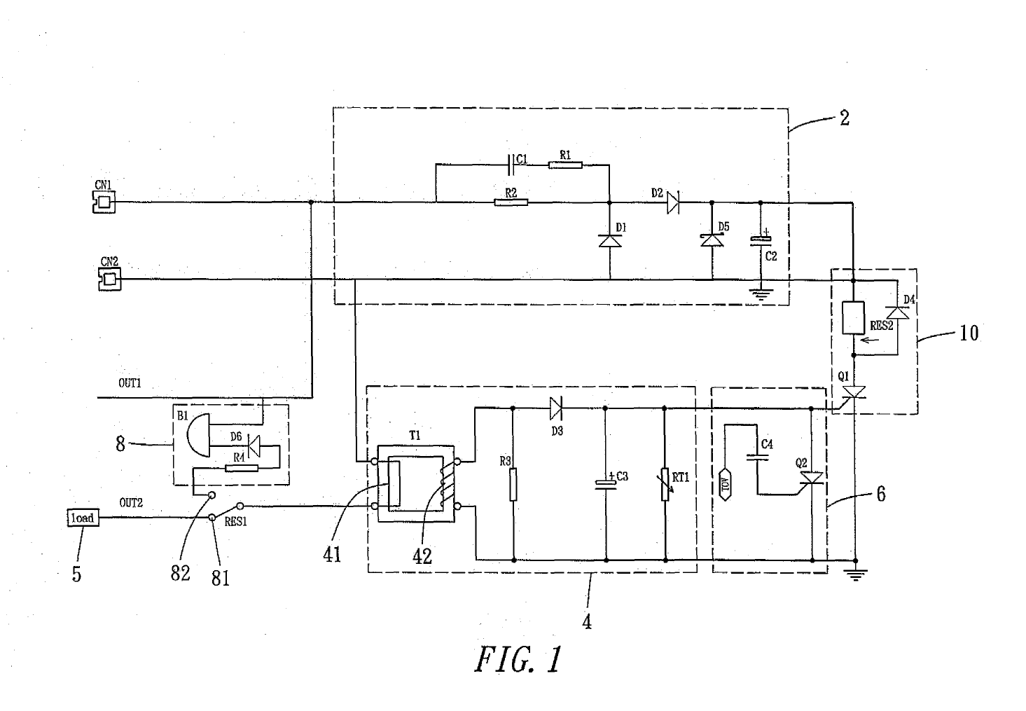

Referring to FIG. 1, a current limiter in accordance with the preferred embodiment of the present invention comprises a circuit device. The circuit device of the current limiter comprises a power supply transformation circuit 2 to transform an alternating-current power supply into a direct-current power supply, a detection circuit 4 to sense and detect a load current from a load 5 (such as a lamp) and to transform the load current of the load 5 into an output voltage with a predetermined ratio, a first relay RES1 electrically connected between the load 5 and the detection circuit 4, a control circuit 10 electrically connected between the detection circuit 4 and the power supply transformation circuit 2 to drive a first silicon control rectifier (SCR) Q1 and a second relay RES2 according to the output voltage of the detection circuit 4 to interrupt a connection between the power supply and the load 5 so as to turn off the load 5, a reset switch circuit 6 electrically connected with the detection circuit 4 and including a second silicon control rectifier Q2, a capacitor C4 electrically connected with the second silicon control rectifier Q2 and a reset switch TOV electrically connected with the capacitor C4 to trigger the second silicon control rectifier Q2 to connect the power supply with the load 5 so as to turn on the load 5, and a protection circuit 8 electrically connected with the first relay RES1 and including a warning element B1.

The power supply transformation circuit 2 includes two input terminals CN1 and CN2, a resistor R1, a resistor R2, a capacitor C1, an energy-storage filter capacitor C2, a diode D1, a diode D2 and a steady-state voltage diode D5.

The input terminals CN1 and CN2 of the power supply transformation circuit 2 are electrically connected with the alternating-current power supply. The resistor R2 and the diode D1 are connected with the input terminals CN1 and CN2 respectively. The capacitor C1 and the resistor R1 are connected serially. The capacitor C1 and the resistor R1 are connected with the resistor R2 in parallel. The diode D2 has a positive pole electrically connected with the negative pole of the diode D1. The steady-state voltage diode D5 has a negative pole electrically connected with the negative pole of the diode D2. The positive pole of the steady-state voltage diode D5, the positive pole of the diode D1 and the input terminal CN2 are grounded. The energy-storage filter capacitor C2 is electrically connected with the steady-state voltage diode D4 in parallel. The energy-storage filter capacitor C2 has a positive pole to function as a direct-current output terminal of the power supply transformation circuit 2a and a negative pole that is grounded.

In practice, an alternating current of the alternating-current power supply is supplied into the input terminals CN1 and CN2 of the power supply transformation circuit 2. Then, the alternating current passes through the capacitor C1, the resistor R1 and the resistor R2. Then, the alternating current passes through the diode D2 which rectifies the alternating current. Then, the rectified alternating current passes through the steady-state voltage diode D4 to perform a voltage stabilizing process. At this time, the capacitive reactance of the capacitor C1 is mush greater than the resistance of the resistor R1 and the resistor R2, so that when the alternating current passes through the capacitor C1, the resistor R1 and the resistor R2, the voltage drop is mainly concentrated on the capacitor C1. In such a manner, the capacitor C1 of the power supply transformation circuit 2 drops the voltage so that the power supply transformation circuit 2 can drop the voltage of the alternating-current power supply by the capacitor C1 without needing a transformer so as to function as a simple direct-current steady-state voltage output circuit. Thus, the power supply transformation circuit 2 has a smaller volume and has a simplified structure, thereby saving the space and the price.

The detection circuit 4 includes a current transformer T1, a resistor R3, a rectifying diode D3, a capacitor C3 (such as an energy-storage capacitor) and a resistor RT1.

The current transformer T1 of the detection circuit 4 is used to transform the load current of the load 5 into the output voltage. The predetermined ratio of the output voltage of the detection circuit 4 is about 1:1. The current transformer T1 of the detection circuit 4 consists of a primary coil 41 and a secondary coil 42. The primary coil 41 of the current transformer T1 of the detection circuit 4 is electrically connected between the input terminal CN2 of the power supply transformation circuit 2 and the first relay RES1. The first relay RES1 is electrically connected with the load 5 by an outlet terminal OUT2 to sense the load current of the load 5. The secondary coil 42 of the current transformer T1 of the detection circuit 4 forms a voltage signal output terminal of the detection circuit 4. The voltage signal output terminal (or the secondary coil 42 of the current transformer T1) of the detection circuit 4 is connected with to a positive pole of the rectifying diode D3 to produce a positive voltage signal output of the detection circuit 4.

The primary coil 41 of the current transformer T1 of the detection circuit 4 has a coil number relatively larger than that of the secondary coil 42 so that when the current in the primary coil 41 of the current transformer T1 of the detection circuit 4 produces a very little variation, the output voltage of the secondary coil 42 produces a very large variation. Thus, the current transformer T1 of the detection circuit 4 has a larger signal variation ratio to facilitate the detection circuit 4 detecting the load current of the load 5

The resistor R3 of the detection circuit 4 is electrically connected with the voltage signal output terminal of the detection circuit 4 in parallel to receive most of the energy of a rush voltage when the abnormal voltage reaction happens in the circuit and to limit the abnormal voltage to a safe range so as to ensure the safety and stability of the circuit.

The capacitor C3 of the detection circuit 4 is electrically connected with the voltage signal output terminal of the detection circuit 4 in parallel to make the direct-current component of the voltage signal output terminal of the detection circuit 4 more smooth.

The resistor RT1 of the detection circuit 4 is electrically connected with the voltage signal output terminal of the detection circuit 4 in parallel. Thus, the resistor RT1 of the detection circuit 4 is used to release an electrical energy stored by the capacitor C3 of the detection circuit 4 when the power supply is interrupted.

The second silicon control rectifier Q2 of the reset switch circuit 6 has a positive pole electrically connected with the negative pole of the rectifying diode D3, a negative pole that is grounded and a gate electrically connected with the capacitor C4. The reset switch TOV of the reset switch circuit 6 is a contact start switch. Thus, when the reset switch TOV of the reset switch circuit 6 is touched, the gate of the second silicon control rectifier Q2 is triggered to conduct the second silicon control rectifier Q2 to connect the power supply with the load 5 so as to turn on the load 5 again after the power supply is returned.

The warning element B1 of the protection circuit 8 is a warning bell or an indication light and has a first side electrically connected with an outlet terminal OUT1, and the protection circuit 8 further includes a diode D6 having a negative pole electrically connected with a second side of the warning element B1 and a resistor R4 electrically connected between a positive pole of the diode D6 and the first relay RES1. The resistor R4 and the diode D6 of the protection circuit 8 are connected serially to form a current limiting resistor. The first relay RES1 has a normally closed contact 81 electrically connected with the outlet terminal OUT2 and a normally open contact 82 electrically connected with the resistor R4 of the protection circuit 8.

Thus, the first relay RES1 is disposed at a normally-closed state so that the warning element B1 of the protection circuit 8 is turned off at the normal state. When an overload condition happens due to an excessive load current passing through the load 5, the first relay RES1 is changed from the normally-closed state to a normally-open state to turn off the load 5 so as to prevent the load 5 from being worn out due to an excessive load current and to turn on the warning element B1 of the protection circuit 8 so as to inform a user of the abnormal condition. On the other hand, when the reset switch TOV of the reset switch circuit 6 is touched, the gate of the second silicon control rectifier Q2 is triggered to conduct the second silicon control rectifier Q2 so that the first relay RES1 is changed from the normally-open state to the normally-closed state to connect the power supply with the load 5 so as to turn on the load 5 again after the power supply is returned and to turn off the warning element B1 of the protection circuit 8.

The second relay RES2 of the control circuit 10 is electrically connected between the direct-current output terminal of the power supply transformation circuit 2 and the positive pole of the first silicon control rectifier Q1 of the control circuit 10 and is electrically connected with the first relay RES1. The second relay RES2 of the control circuit 10 is operated to shut the power supply so as to turn off the load 5. The first silicon control rectifier Q1 of the control circuit 10 has a negative pole that is grounded and a gate electrically connected with the voltage signal output terminal of the detection circuit 4 and the positive pole of the second silicon control rectifier Q2 of the reset switch circuit 6. The control circuit 10 further includes a diode D4 electrically connected with the second relay RES2 in parallel and having a positive pole electrically connected with the positive pole of the first silicon control rectifier Q1 of the control circuit 10 and a negative pole electrically connected with the direct-current output terminal of the power supply transformation circuit 2.

In practice, when the load current passing through the load 5 exceeds a predetermined value, the voltage signal output terminal of the detection circuit 4 produces a conducting voltage. When the conducting voltage is supplied between the negative pole and the gate of the first silicon control rectifier Q1 of the control circuit 10, the negative pole and the positive pole of the first silicon control rectifier Q1 of the control circuit 10 are conducted. On the contrary, when the conducting voltage between the negative pole and the gate of the first silicon control rectifier Q1 of the control circuit 10 disappears, the negative pole and the positive pole of the first silicon control rectifier Q1 of the control circuit 10 are disconnected. Thus, when the negative pole and the positive pole of the first silicon control rectifier Q1 are conducted, the direct-current voltage of the direct-current output terminal of the power supply transformation circuit 2 is applied onto the second relay RES2 of the control circuit 10 to energize and start the second relay RES2 which drives the first relay RES1 so that the first relay RES1 is changed from the normally-closed state to the normally-open state to turn off the load 5 so as to prevent the load 5 from being worn out due to an excessive load current and to turn on the warning element B1 of the protection circuit 8 so as to inform a user of the abnormal condition.

In addition, when the reset switch TOV of the reset switch circuit 6 is touched, the gate of the second silicon control rectifier Q2 is triggered to conduct the second silicon control rectifier Q2 to connect the power supply with the load 5 so as to turn on the load 5 again after the power supply is returned.

In addition, when the negative pole and the positive pole of the first silicon control rectifier Q1 are disconnected, the two terminals of the second relay RES2 will produce a positive high voltage which is applied on the diode D4 so that the diode D4 can release the positive high voltage of the second relay RES2 to prevent the positive high voltage of the second relay RES2 from directly impacting and burning the first silicon control rectifier Q1 when the negative pole and the positive pole of the first silicon control rectifier Q1 are disconnected.

It is to be noted that, the resistor RT1 of the detection circuit 4 is used to release the electrical energy stored by the energy-storage capacitor C3 of the detection circuit 4 when the power supply to the load 5 is interrupted to turn off the load 5. Thus, the voltage of the energy-storage capacitor C3 of the detection circuit 4 will not be greater than the conducting voltage of the first silicon control rectifier Q1 to prevent the negative pole and the positive pole of the first silicon control rectifier Q1 of the control circuit 10 from being conducted and to prevent the first relay RES1 from being disposed at the normally-open state constantly so that the load 5 can be turned on after the reset switch TOV of the reset switch circuit 6 is touched.

In conclusion, the current limiter is mounted on a load 5 (such as a lamp) to limit the power of the load 5. Thus, when the power of the load 5 exceeds a predetermined value (such as 190 W), the current limiter will shut the power supply automatically to turn off the load 5 so as to prevent the load 5 from being worn out due to an excessive load current and to turn on the warning element B1 of the protection circuit 8 so as to inform a user of the abnormal condition. Thus, after the load 5 is replaced to have a power smaller than 190 W, the power supply is restored after the reset switch TOV of the reset switch circuit 6 is touched so as to turn on the load 5.

Accordingly, when the power of the load 5 exceeds a predetermined value, the current limiter will shut the power supply automatically to turn off the load 5 so as to prevent the load 5 from being worn out due to an excessive load current and to turn on the warning element B1 of the protection circuit 8 so as to inform a user of the abnormal condition due to the overload of the load 5. In addition, the power supply transformation circuit 2 has a smaller volume and has a simplified structure, thereby saving the space and the price.

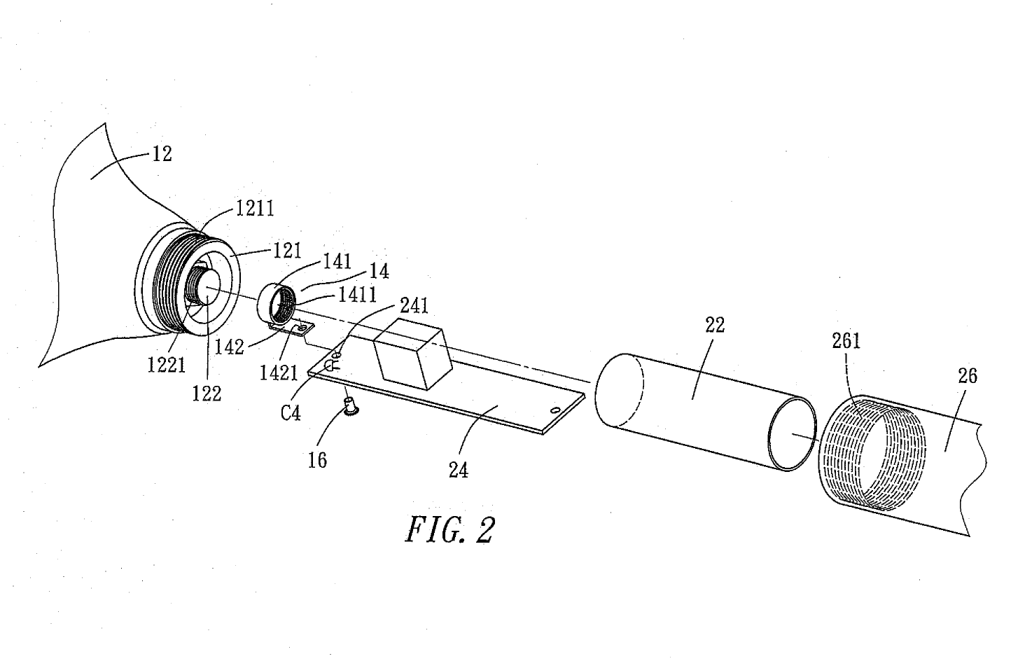

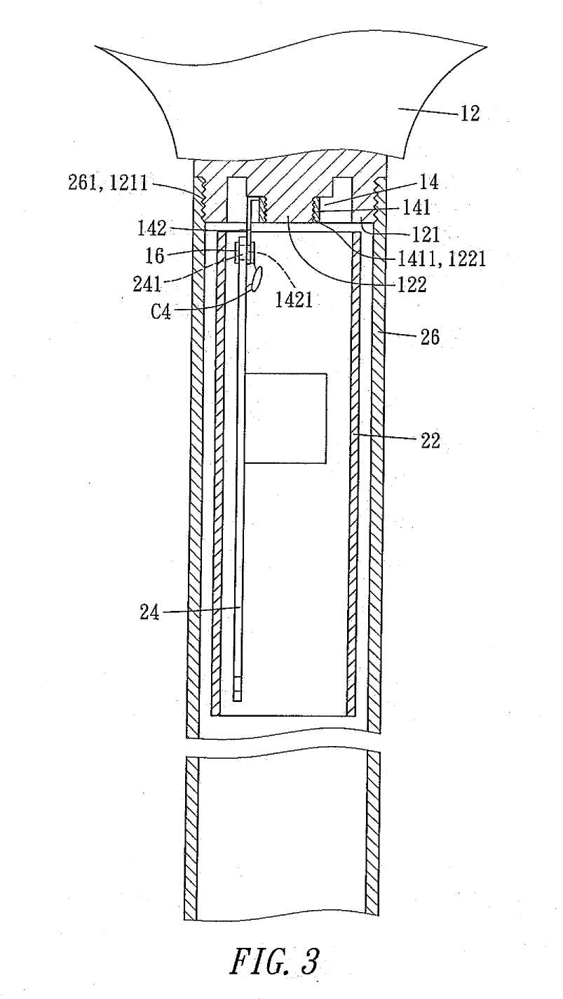

Referring to FIGS. 2 and 3, the current limiter further comprises a lamp device. The lamp device of the current limiter comprises a lamp shade 12, an outer sleeve 26 connected with the lamp shade 12, a metallic bracket 14 connected with the lamp shade 12 and located in the outer sleeve 26, a printed circuit board (PCB) 24 containing the circuit device therein and connected with the metallic bracket 14, a fastener 16 (such as a rivet) connecting the printed circuit board 24 and the metallic bracket 14 together and electrically connected with the capacitor C4 of the reset switch circuit 6, and an insulating tube 22 mounted on the printed circuit board 24 and located in the outer sleeve 26.

The lamp shade 12 is made of metal and has an inside provided with a light emitting member, such as an electric bulb. The lamp shade 12 has an end portion provided with a mounting cylinder 121 and a mounting post 122 located in the mounting cylinder 121. The mounting cylinder 121 of the lamp shade 12 is provided with an outer threaded portion 1211, and the mounting post 122 of the lamp shade 12 is provided with an outer threaded section 1221. The metallic bracket 14 includes a mounting ring 141 mounted on the mounting post 122 of the lamp shade 12 and a connecting plate 142 having a first end secured on a periphery of the mounting ring 141 and a second end connected with the metallic bracket 14 by the fastener 16. The mounting ring 141 of the metallic bracket 14 is provided with an inner threaded section 1411 screwed onto the outer threaded section 1221 of the mounting post 122. The connecting plate 142 of the metallic bracket 14 is provided with a fixing hole 1421 for fixing the fastener 16. The printed circuit board 24 has an end portion provided with a fixing bore 241 to allow passage of the fastener 16. The outer sleeve 26 is made of metal and is used to support the lamp shade 12. The outer sleeve 26 is mounted on the mounting cylinder 121 of the lamp shade 12 and is provided with an inner threaded portion 261 screwed onto the outer threaded portion 1211 of the mounting cylinder 121. The insulating tube 22 has a heat contractible feature to clamp the printed circuit board 24. The capacitor C4 of the reset switch circuit 6 is placed on the printed circuit board 24 and has a leg soldered on the fastener 16 so that the capacitor C4 of the reset switch circuit 6 is electrically connected with the metallic bracket 14.

In such a manner, the metallic bracket 14, the outer sleeve 26 and the lamp shade 12 are electrically connected with each other, so that the outer sleeve 26 and the lamp shade 12 can function as the reset switch TOV of the reset switch circuit 6. Thus, the electric power to the lamp device of the current limiter is shut when the overload happens and is returned by touching the outer sleeve 26 or the lamp shade 12 after the overload is eliminated.

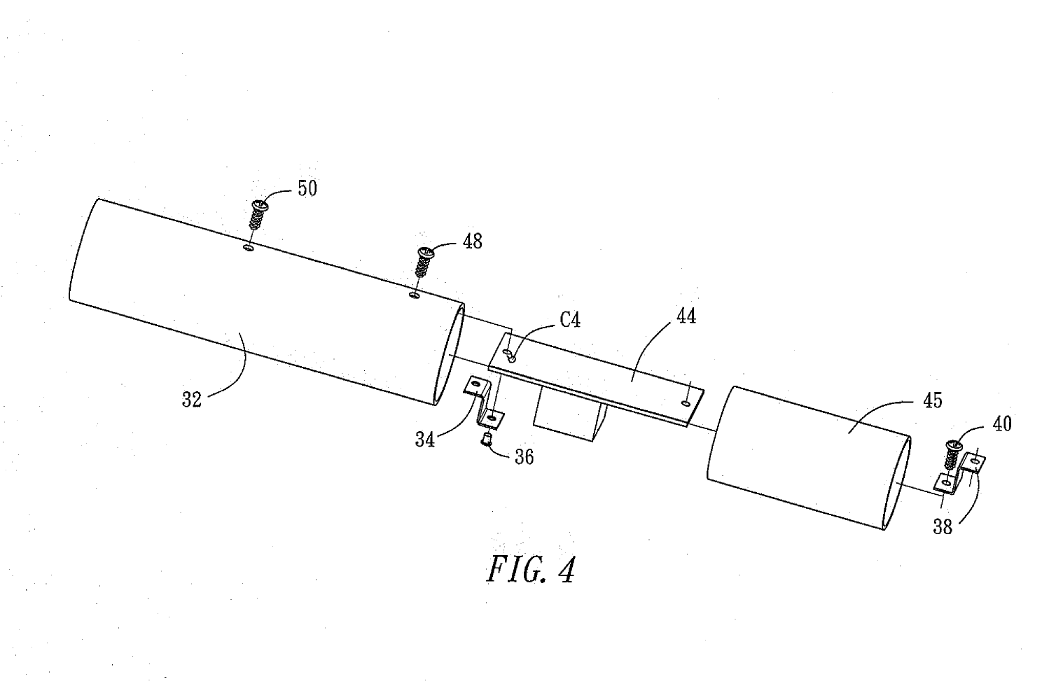

Referring to FIG. 4, the lamp device of the current limiter comprises an outer sleeve 32, an insulating tube 45 mounted in the outer sleeve 32 to receive a printed circuit board 44 which contains the circuit device therein, a first terminal 34 having a first portion combined with a first end of the printed circuit board 44 by a fastener 36 (such as a rivet) which is electrically connected with the capacitor C4 of the reset switch circuit 6 and a second portion combined with the outer sleeve 32 by a fastening member 50 (such as a screw), and a second terminal 38 having a first portion combined with a second end of the printed circuit board 44 by a fastening member 40 (such as a screw) and a second portion combined with the outer sleeve 32 by a fastening member 48 (such as a screw).

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A current limiter, comprising:
a circuit device comprising
a power supply transformation circuit to transform an alternating-current power supply into a direct-current power supply;
a detection circuit to sense and detect a load current from a load and to transform the load current of the load into an output voltage with a predetermined ratio;
a first relay electrically connected between the load and the detection circuit;
a control circuit electrically connected between the detection circuit and the power supply transformation circuit to drive a first silicon control rectifier and a second relay according to the output voltage of the detection circuit to interrupt a connection between the power supply and the load so as to turn off the load;
a reset switch circuit electrically connected with the detection circuit and including a second silicon control rectifier, a capacitor electrically connected with the second silicon control rectifier and a reset switch electrically connected with the capacitor to trigger the second silicon control rectifier to connect the power supply with the load so as to turn on the load;
a protection circuit electrically connected with the first relay and including a warning element.

2. The current limiter in accordance with claim 1, wherein the detection circuit includes a current transformer to transform the load current of the load into the output voltage.

3. The current limiter in accordance with claim 1, wherein the predetermined ratio of the output voltage of the detection circuit is about 1:1.

4. The current limiter in accordance with claim 1, wherein the control circuit further includes a diode electrically connected with the second relay in parallel.

5. The current limiter in accordance with claim 4, wherein
the second relay of the control circuit is electrically connected between a direct-current output terminal of the power supply transformation circuit and the positive pole of the first silicon control rectifier of the control circuit.
the diode of the control circuit has a positive pole electrically connected with the positive pole of the first silicon control rectifier of the control circuit and a negative pole electrically connected with the direct-current output terminal of the power supply transformation circuit.

6. The current limiter in accordance with claim 1, wherein the warning element of the protection circuit is a warning bell or an indication light.

7. The current limiter in accordance with claim 2, wherein
the current transformer of the detection circuit consists of a primary coil and a secondary coil;
the primary coil of the current transformer of the detection circuit is electrically connected between an input terminal of the power supply transformation circuit and the first relay;
the secondary coil of the current transformer of the detection circuit forms a voltage signal output terminal of the detection circuit.

8. The current limiter in accordance with claim 7, wherein
the voltage signal output terminal of the detection circuit is connected with to a positive pole of a rectifying diode to produce a positive voltage signal output of the detection circuit;
the second silicon control rectifier of the reset switch circuit has a positive pole electrically connected with the negative pole of the rectifying diode and a negative pole that is grounded and a gate electrically connected with the capacitor.

9. The current limiter in accordance with claim 1, wherein the second silicon control rectifier of the reset switch circuit has a gate electrically connected with the capacitor.

10. The current limiter in accordance with claim 1, wherein the first relay is electrically connected with the load by an outlet terminal to sense the load current of the load.

11. The current limiter in accordance with claim 1, wherein the reset switch of the reset switch circuit is a contact start switch.

12. The current limiter in accordance with claim 5, wherein second relay of the control circuit is electrically connected with the first relay.

13. The current limiter in accordance with claim 1, wherein
the warning element of the protection circuit has a first side electrically connected with an outlet terminal;
the protection circuit further includes a diode having a negative pole electrically connected with a second side of the warning element and a resistor electrically connected between a positive pole of the diode and the first relay.

14. The current limiter in accordance with claim 13, wherein
the resistor and the diode of the protection circuit are connected serially to form a current limiting resistor;
the first relay has a normally closed contact electrically connected with the outlet terminal and a normally open contact electrically connected with the resistor of the protection circuit.

15. The current limiter in accordance with claim 7, wherein the first silicon control rectifier of the control circuit has a negative pole that is grounded and a gate electrically connected with the voltage signal output terminal of the detection circuit and the positive pole of the second silicon control rectifier of the reset switch circuit.

16. The current limiter in accordance with claim 1, further comprising a lamp device which comprises:
a lamp shade;
an outer sleeve connected with the lamp shade;
a metallic bracket connected with the lamp shade and located in the outer sleeve;
a printed circuit board containing the circuit device therein and connected with the metallic bracket;
a fastener connecting the printed circuit board and the metallic bracket together and electrically connected with the capacitor of the reset switch circuit;
an insulating tube mounted on the printed circuit board and located in the outer sleeve.

17. The current limiter in accordance with claim 16, wherein
the lamp shade has an end portion provided with a mounting cylinder and a mounting post located in the mounting cylinder;
the metallic bracket includes a mounting ring mounted on the mounting post of the lamp shade and a connecting plate having a first end secured on a periphery of the mounting ring and a second end connected with the metallic bracket by the fastener;
the outer sleeve is mounted on the mounting cylinder of the lamp shade.

18. The current limiter in accordance with claim 17, wherein
the mounting cylinder of the lamp shade is provided with an outer threaded portion;
the mounting post of the lamp shade is provided with an outer threaded section;
the mounting ring of the metallic bracket is provided with an inner threaded section screwed onto the outer threaded section of the mounting post;
the outer sleeve is provided with an inner threaded portion screwed onto the outer threaded portion of the mounting cylinder.

19. The current limiter in accordance with claim 16, wherein
the metallic bracket, the outer sleeve and the lamp shade are electrically connected with each other;
the outer sleeve and the lamp shade can function as the reset switch of the reset switch circuit.

20. The current limiter in accordance with claim 17, wherein
the lamp shade is made of metal;
the connecting plate of the metallic bracket is provided with a fixing hole for fixing the fastener;
the printed circuit board has an end portion provided with a fixing bore to allow passage of the fastener;
the outer sleeve is made of metal;
the insulating tube has a heat contractible feature to clamp the printed circuit board;
the capacitor of the reset switch circuit is placed on the printed circuit board and has a leg soldered on the fastener so that the capacitor of the reset switch circuit is electrically connected with the metallic bracket.
